(19) United States
(12) Patent Application Publication
(10) Pub. No.: US 2004/0141008 A1
(43) Pub. Date: Jul. 22, 2004

(54) Positioning of areas displayed on a user interface

(76) Inventors: Alexander Jarczyk, Freising (DE); Birgit Otto, Munchen (DE)

Correspondence Address: STAAS & HALSEY LLP, SUITE 700, 1201 NEW YORK AVENUE, N.W., WASHINGTON, DC, 20005, US

(21) Appl. No.: 10/471,098

(22) PCT Filed: Feb. 25, 2002
(86) PCT No.: PCT/DE02/00680

(30) Foreign Application Priority Data
Mar. 7, 2001 (DE) 101 10 943.1

(51) Int. Cl. G09G 5/00

(52) U.S. Cl. 345/781

(57) ABSTRACT

The invention relates to a method for controlling a data processing system via a user interface on which user interface image objects can be displayed in a plurality of areas. The user interface image object call is associated with the execution of a defined function of the data processing system. The inventive method is further characterized in that the areas share part of the user interface. The areas are displayed in different sizes on the user interface depending on the choice made by the data processing system's user. When a certain area is activated, it is displayed in a preferred position of the user interface while the other areas are grouped around the activated area.

The invention relates to a method for controlling a data processing system via a user interface, to a data processing system with display facilities for displaying a user interface, and to a program product for a data processing system.

Only very small display facilities are available on data processing systems in the form of small terminals such as, for example, PDAs (Personal Digital Assistants) or navigation devices. For this reason, where possible the entire area of the display facility should be used for an application running on the terminal. Although in the majority of cases it is possible here to change between different applications by means of hardkeys or pop-up menus, interaction between applications or groups of applications is only possible by means of cutting followed by pasting and not by means of direct manipulation such as, for example, dragging followed by dropping (Drag & Drop).

To facilitate operating the data processing system, a method is known whereby a bar is provided along the edge of the user interface presented on the display facilities via which a pop-up menu can be called up or in which other programs' user interface image objects (icons) functioning as configurable softkeys are arranged. Alternatively, for designated programs there are hardkeys, which is to say real keys, via which a program can be called up directly. The sole interaction possible between two programs is cutting in the first program followed by calling up the second program and pasting in the second program. This procedure during which it is not possible in particular optically to tell what is happening to the cut object while the operation is in progress is unclear for users of the data processing system, difficult to follow, and leads to cognitive overload. This results in errors in operating the data processing system and hence in an impairment of the system's technical functionality.

Proceeding from this, the technical object of the invention is to simplify the operational flow of data processing systems and make them easier and faster to control. The object in particular is to make a data processing system and a method for controlling a data processing system available wherein the possibility of making operating errors is reduced to a maximum extent.

The object is achieved by means of a method for controlling a data processing system, by means of a data processing system, and by means of a program product with the features of the independent claims.

The data processing system is controlled via a user interface on which user interface image objects are displayed in each of several areas. The execution of a defined function of the data processing system is associated with calling up a user interface image object. This is generally the execution of a program associated with the user interface image object or the execution of a standard program for the type of document of which the document assigned to the user interface image object is an instance. Although the areas in which the user interface image objects are respectively displayed do not necessarily fill the entire user interface, they share at least part of the user interface. The areas are displayed on the user interface in different sizes. Users can choose to activate or deactivate areas. For an activated area at least one user interface image object is displayed in such a way that the user interface image object can be directly accessed via, for example, the keyboard. If an area is then activated, it will be displayed at a preferred, permanently assigned position on the user interface. As a countermove, the other, deactivated areas will be grouped around the activated area. This grouping takes place in particular automatically through the other areas' being displayed along the edge or close to the edge of the activated area.

The preferred position is preferably situated approximately in the center of that part of the user interface shared by the areas.

In order to improve the accessibility of the user interface image objects associated with the activated area, this area in particular is displayed in enlarged form.

In order further to automate the procedural flow, another, previously activated area can be deactivated or all other, previously activated areas can be deactivated as soon as an area is newly activated. Areas that are deactivated are reduced in size.

Only one area is preferably activated at a time and the areas are displayed separately according to the method.

The user interface can be made easier to operate if it can be controlled by means of an instrument for pointing. With respect to the user interface, the instrument for pointing can have a virtual embodiment, taking the form of a mouse, for example, or a real embodiment, taking the form of a pen or finger, for example.

User interface image objects can be transported from one area to another with the aid of the instrument for pointing by being selected with the instrument for pointing, then dragged from one area to the other and dropped there. The area to which the user interface image object is dragged is preferably activated by dragging of the user interface image object to this area. This is accordingly displayed in large format in the center of the display facilities of the data processing system and the other, now deactivated areas are grouped around it.

The user interface image object that was dragged to the other area and dropped there is preferably displayed along the edge of this area, which is adjacent to the area from which the user interface image object was dragged. Instead of the user interface image object's being moved to the other area, as an option or a default setting it is also possible to produce a link in the other area. The link is also displayed in the form of a user interface image object and is a link either to the original user interface image object or to the file associated with the user interface image object.

Any area can generally be activated by marking it by clicking on it with the aid of, for instance, the instrument for pointing.

A particularly clear presentation, and one associated with enhanced enjoyment in terms of fun for the user, will result if, on activation of the area being activated, the activated area and other area are positioned such that a rolling effect is produced. If the deactivated areas are only grouped along the top and bottom edge of the activated area, a rolling effect of this type will be produced by always positioning the areas as though they were arranged in a fixed sequence along a band obtained when the top side of the user interface's upper part in which the areas are displayed is linked to the bottom side of that part. This band will then practically constitute the surface of a roll, with the roll being turned each time the areas are repositioned through the activation of a previously deactivated area in such a way that the activated area is displayed at the preferred position.

If the deactivated areas are displayed in several directions along the edge of the respectively activated area, the part of the user interface in which the areas are displayed can accordingly be mentally visualized as being linked into a sphere at its external edges. Instead of a band, a sphere will then be rolled in order to display the respectively activated area at a preferred position, with the adjacency relationships between the individual areas being again retained. The latter in particular helps substantially to improve the user's orientation on the user interface.

The process of reducing the size of the deactivated areas can generally also be dispensed with. These areas are instead or additionally merely moved when being positioned around the activated area. To reinforce the rolling effect, they are in particular moved from that part of the user interface shared by the areas and/or displaced to the opposite side. The deactivated areas are in this case preferably only displayed partially in order to provide sufficient space on the user interface for the activated area.

The adjacency relationships facilitating user orientation can be sustained for the more general case of the areas' being positioned such that the non-activated areas are situated along the edge or close to the edge of the activated area by always having in each case two areas arranged adjacently along their same edges regardless of which area has been activated.

If the active area is displayed as a polygon, the areas are preferably positioned such that a non-activated area or several non-activated areas is/are in each case situated along a side of the polygon which is displayed as the active area.

The adjacency relationships can also be maintained here by having the areas positioned such that two areas are in each case always arranged adjacently along their same sides regardless of which area has been activated.

The method is advantageously embodied such that the areas are, at each step, positioned and selected with regard to size in such a way that all areas are displayed on the part of the user interface.

Furthermore, the areas can at each step of the method be positioned and selected with regard to size such that no area obscures a partial area of another area.

In keeping with the method according to the invention, a user interface is in particular made available for an operating system.

The invention furthermore relates to an arrangement, in particular to a data processing system, which is set up in order to implement one of the preceding methods. An arrangement of this type can be realized by means of, for example, suitably programming and setting up a computer, PDAs in particular, or a computing system.

A program product for a data processing system containing software code sections with which one of the described methods can be put into effect on the data processing system can be realized by suitably implementing the method in a programming language and converting it into a code that can be executed by the data processing system. The software code sections are stored for this. A program product here refers to the program as a marketable product. It can be made available in any form, for example on paper, on a computer-readable data medium, or distributed over a network.

Further major features and advantages of the invention will emerge from the description of an exemplary embodiment with the aid of the drawing.

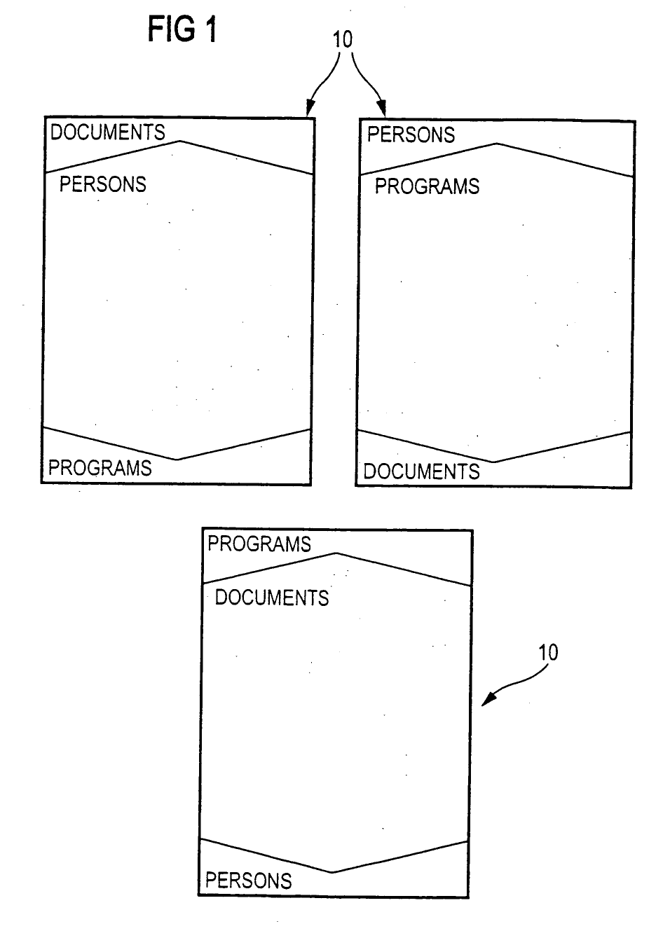

FIG. 1 shows an exemplary embodiment with three areas

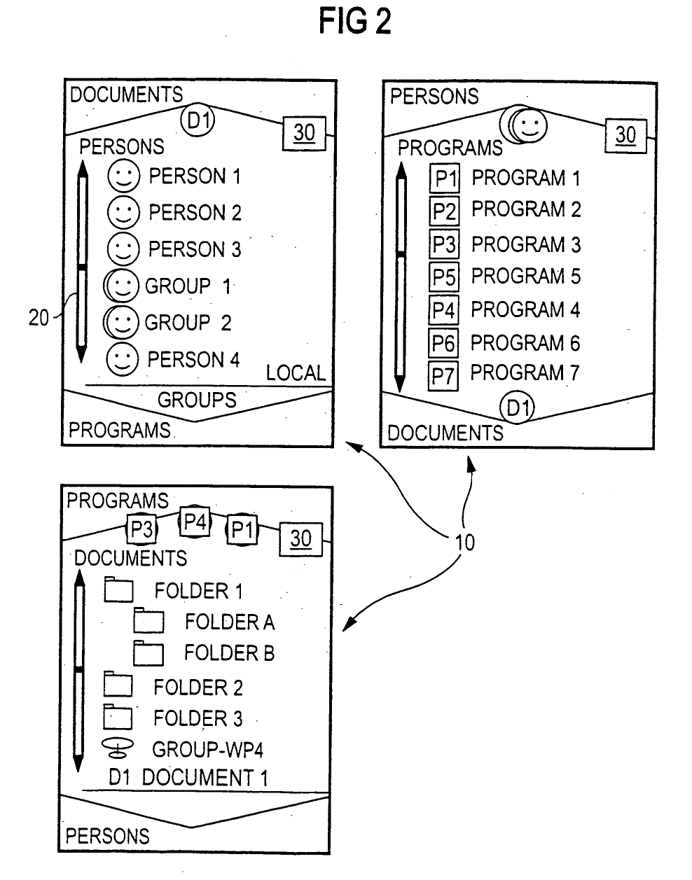

FIG. 2 shows the exemplary embodiment according to FIG. 1 with displayed user interface image objects

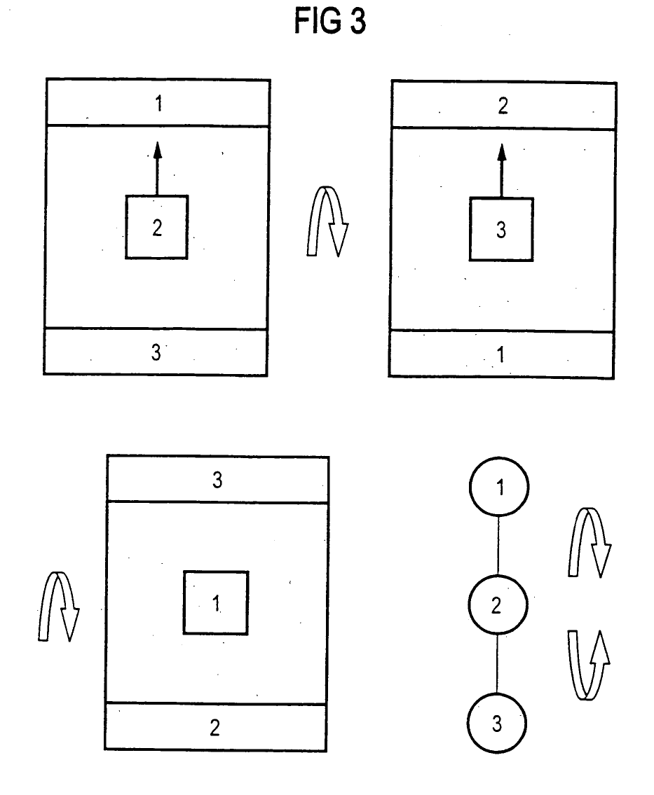

FIG. 3 shows a rolling effect for three areas

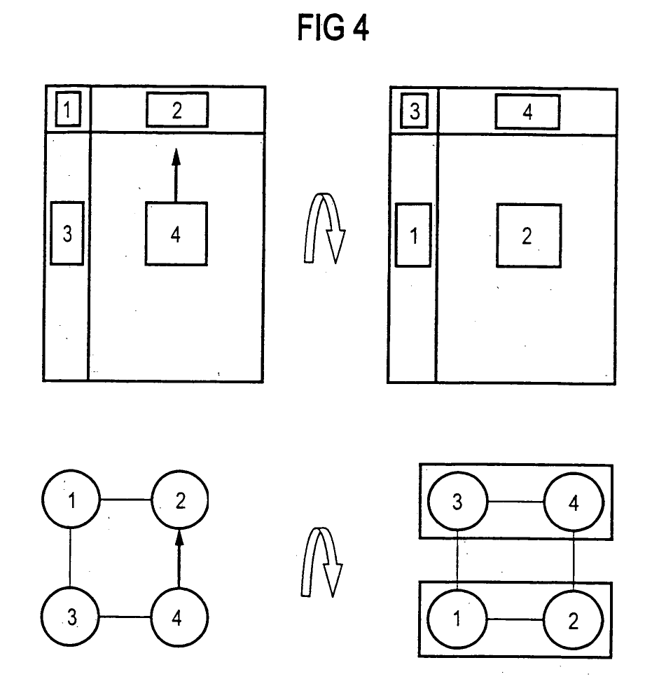

FIG. 4 shows a rolling effect for four areas

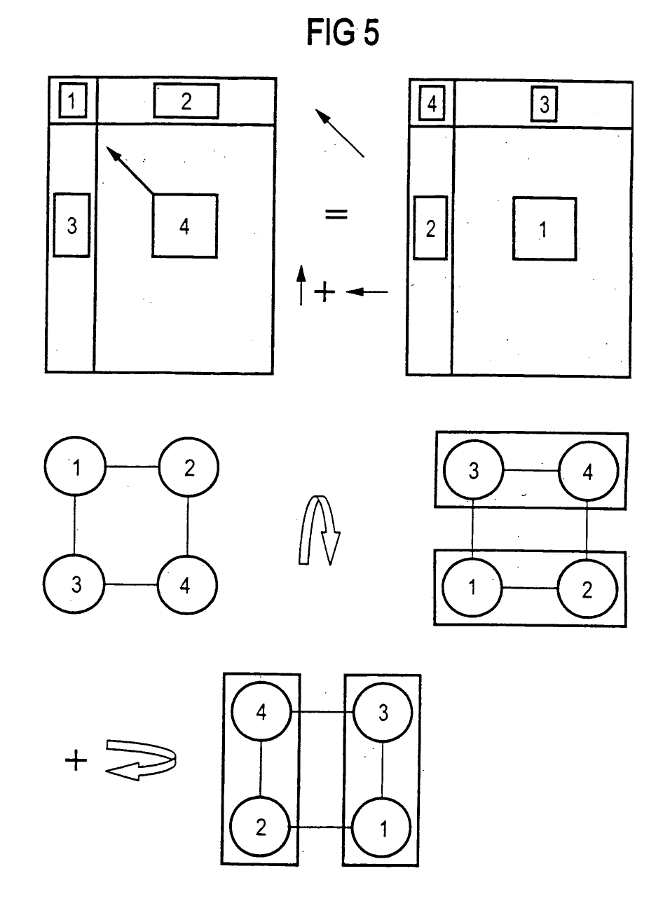

FIG. 5 shows the rolling effect for four areas in a different direction

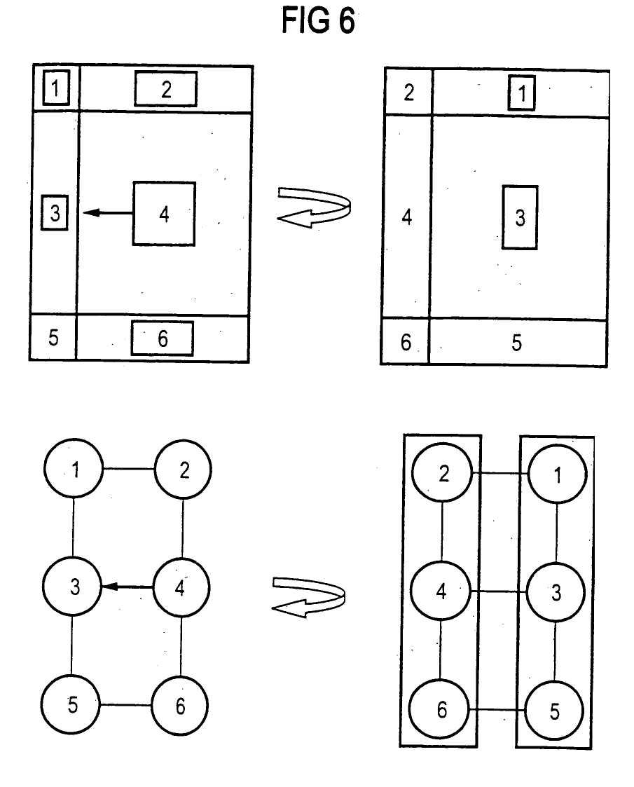

FIG. 6 shows a rolling effect for six areas

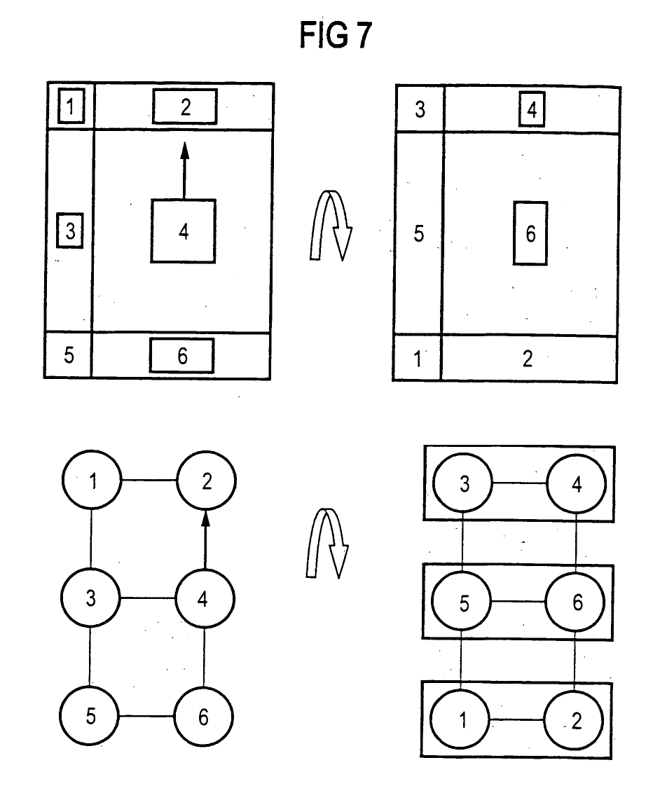

FIG. 7 shows the rolling effect for six areas in a different direction

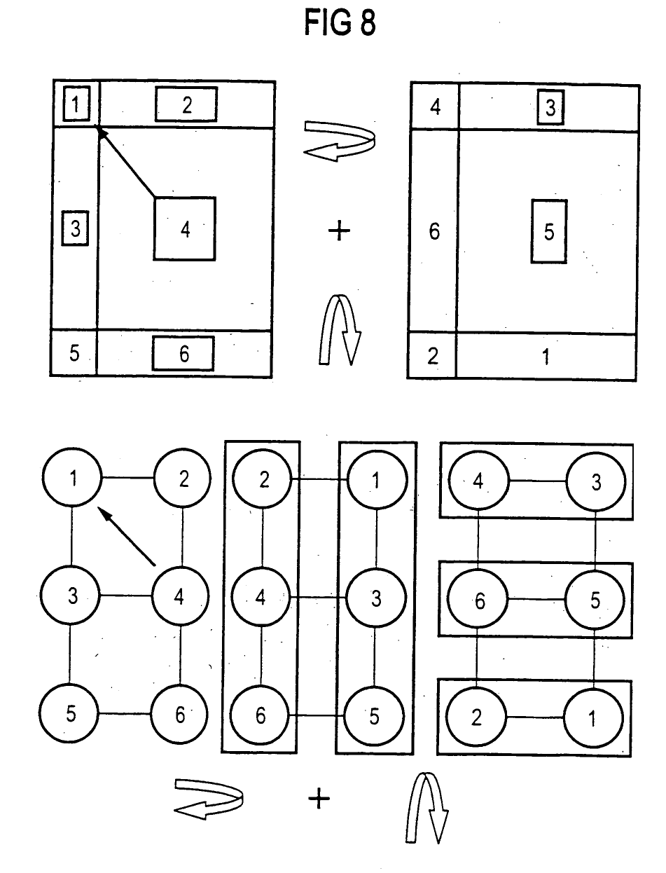

FIG. 8 shows the rolling effect for six areas in another direction

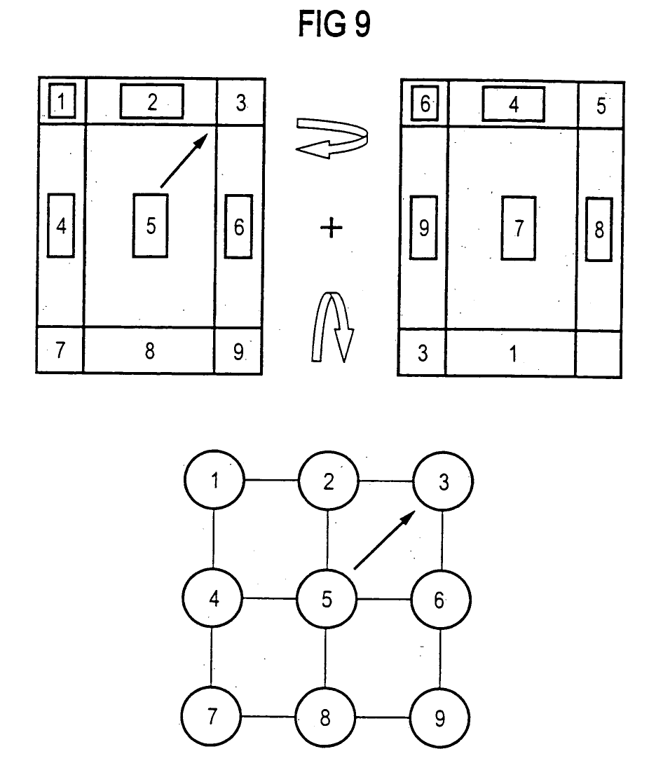

FIG. 9 shows a rolling effect for nine areas

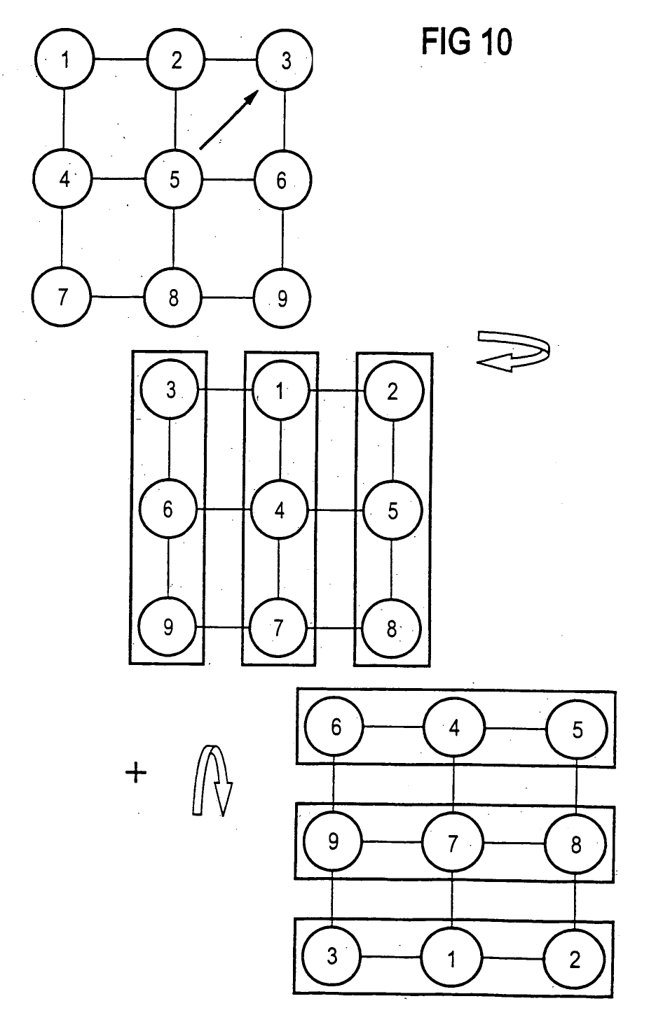

FIG. 10 shows the scheme underlying the rolling effect for nine areas.

FIG. 1 shows a part 10 of a user interface at three different instants in time. Part 10 of the user interface is shared by the three areas PERSONS, DOCUMENTS, and PROGRAMS.

The PERSONS area is activated at a first instant in time.

At a second instant in time the PROGRAMS area is activated through a user selection. By means of the method for controlling the data processing system by which the user interface is displayed, the PROGRAMS area is then displayed at a preferred position on the user interface approximately in the center of part 10 of the user interface, while the other DOCUMENTS and PERSONS areas are grouped around the activated PROGRAMS area. The other areas are grouped around the activated area by being repositioned. The PROGRAMS area which is activated is shown in a larger format. The previously activated PERSONS area is deactivated and reduced in size.

The three areas are separate, meaning they do not overlap.

At a third instant in time the DOCUMENTS area is activated through a user selection by means of an instrument for pointing that is not shown here. This is done by pointing with the instrument for pointing at the DOCUMENTS area being activated and marking it by depressing the instrument for pointing or a corresponding key.

The DOCUMENTS area being activated is then displayed at the same preferred position approximately in the center of part 10 of user interface shared by the areas. The other PERSONS and PROGRAMS areas are grouped around the activated area by being displayed along that area's top or bottom edge. This means that no more than one deactivated area at a time is displayed between the activated area and the edge of part 10 of the user interface shared by the areas.

By dwelling for an extended period of time over a deactivated area with the instrument for pointing, or by applying another suitable interaction motion, the user triggers a shifting (scrolling) of the areas resulting in scrolling to the next deactivated area, in particular with use being made of the rolling effect. Scrolling proceeds to the deactivated area situated on the opposite side of part 10 by activating the previously deactivated area over which the instrument for pointing is positioned by the user and displaying this in large format in the center. The previously activated area is deactivated and the other previously deactivated areas are displayed at the location of the previously deactivated area over which the instrument for pointing is positioned by the user. The method then pauses for an instant and the user can decide whether to drag the instrument for pointing, where applicable along with a user interface image object associated with it, into the now newly activated area in order to marry the user interface image object with a user interface image object in this area. Or the user can opt not to move the instrument for pointing and instead continue holding it over the still deactivated area that has arrived at a position below the instrument for pointing through scrolling. Scrolling then resumes after the pause.

The embodiment cited in the last paragraph is especially suitable for a sizable number of deactivated areas in particular if, contrary to the exemplary embodiment, the method is implemented such that more than one deactivated area is displayed between the activated area and the edge of part 10 of the user interface shared by the areas. By dwelling for an extended period of time over a deactivated area with the instrument for pointing, or by applying another suitable interaction motion, the user here triggers a shifting (scrolling) of the areas resulting in scrolling to another deactivated area in a specified sequence.

Part 10 of the user interface shared by the areas occupies the entire user interface.

In FIG. 2 also, part 10 of the user interface can be seen at three different instants of time. In contrast to FIG. 1, user interface image objects are in this case also displayed which were initially omitted in FIG. 1 for better clarity. In the exemplary embodiment the user interface image objects are divided into three separate categories in keeping with the three separate areas PERSONS, PROGRAMS, and DOCUMENTS. Elements can be found in the PERSONS category in the form of persons PERSON 1, PERSON 2, PERSON 3, and PERSON 4, and groups of persons GROUP 1 and GROUP 2. Other groups and persons can be accessed through the possibility of scrolling through the activated PERSONS area on part 10 of the user interface by means of a scroll bar 20.

The elements, groups, and persons are assigned user interface image objects which, in the case of persons, are advantageously embodied as an image of the respective person's head. Instead of this, the user interface image object of a person can also be a general person-related pictogram associated with the person's name.

Elements that do not belong to the category of the activated area but which are to be available in the activated area are made available in the activated area by means of a display of a user interface image object representing the relevant element at the edge of the activated area bordering the display of the area to whose category the element belongs. At the first instant in time in FIG. 2, the DOCUMENT 1 document is made accessible in the activated PERSONS area by means of a display of a user interface image object D1 belonging to the DOCUMENT 1 document at the edge of the PERSONS area bordering the DOCUMENTS area.

Instead of at the edge, the user interface image object could also be displayed close to the edge or on it. Instead of the display in the activated area, user interface image objects that are to be made accessible in other areas can also be displayed in the deactivated area if this takes place at the edge toward the activated area or close to the edge toward the activated area.

In the exemplary embodiment shown, elements that are to be made accessible to another area are in each case displayed in bubbles in the form of circles in order to illustrate for the user the attachment of the relevant user interface image object at the edge of the other area.

If, at the first instant in time, the GROUP 1 group is selected with the aid of an instrument for pointing (not shown), dragged into the PROGRAMS area, and dropped there, this action will activate the PROGRAMS area. The method for controlling the data processing system will then display the PROGRAMS area in enlarged format at the preferred position in the center of part 1 of the user interface shared by the areas. The previously activated PERSONS area is deactivated and displayed reduced in size at the edge of the activated PROGRAMS area at which it was displayed when the PERSONS area was activated and the PROGRAMS area was deactivated. The DOCUMENTS area remains deactivated and reduced in size. However, its representation is moved to part 1 of the user interface so it can continue being displayed at the edge of the PROGRAMS area where it was located before the PROGRAMS area was activated. This edge is formed by conceptually bringing together part 1 of the user interface at its respectively opposite open sides.

Element 1 is made accessible to the activated PROGRAMS area by selecting, dragging, and dropping the user interface image object belonging to the GROUP 1 element. For this, a user interface image object belonging to the GROUP 1 element is displayed in a bubble at the edge between the activated PROGRAMS area and previously activated and now deactivated PERSONS area.

The user interface image object D1 of the DOCUMENT 1 element is further displayed in a bubble at the edge of the PROGRAMS area toward the DOCUMENTS area. This element had been made accessible in a preceding step (not shown) to the PROGRAMS area.

Because the GROUP 1 and DOCUMENT 1 elements were made accessible to the activated area via the associated user interface image objects, users of the data processing system can easily marry the elements with the elements in the PROGRAMS area. In contrast to users of the prior art, they no longer have to note which element they have cut and can optionally also make several elements accessible in another area. They can, for example, marry the GROUP 1 element with the PROGRAM 2 program by dragging the user interface image object belonging to the GROUP 1 element over to the user interface image object P2 of the PROGRAM 2 element and dropping it there.

The function then executed by the data processing system is substantially determined by the nature of the PROGRAM 2 program. For example, in an embodiment of the PROGRAM 2 program as a communication program a conference circuit can be set up to the persons belonging to the GROUP 1 element.

If, on the other hand, the DOCUMENT 1 element is married with the PROGRAM 4 program by dragging the user interface image object D1 over to the user interface image object P4 and dropping it there, it is possible to call up a word processing operation and execute it on the D1 document.

Finally, another conceivable action is to marry both the GROUP 1 element and the DOCUMENT 1 element with a program in order, for instance, to send a mail to all persons belonging to the GROUP 1 element.

If, at the second instant in time, the user interface image objects P1, P3, and P4 of the PROGRAM 1, PROGRAM 3, and PROGRAM 4 programs are marked by means of the instrument for pointing and dragged into the deactivated DOCUMENTS area, this DOCUMENTS area will be activated in the previously described manner and the PROGRAM 1, PROGRAM 3, and PROGRAM 4 programs will be made available by a display of associated user interface image objects P1, P3, and P4 in bubbles at the edge between the DOCUMENTS area and PROGRAMS area.

If an element is to cease being made available to an area to which it does not belong, the user simply selects the associated user interface image object with the aid of the instrument for pointing, drags it back into the area to which it belongs, and drops it there. As an option for this operation, the area in which the user interface image object is dropped can be activated or the activated area from which the user interface image object was removed can remain activated.

Finally, part 10 of the user interface shared by the areas is also provided with a field 30 which the user can select to exit the method and go to other applications.

FIGS. 3 to 10 show how the activated area and other areas can be positioned so as to produce a rolling effect. The method is disclosed for n=3, 4, 6, and 9 areas. However, the method can basically also be implemented with any number of areas n provided the number of areas n is dimensioned so that rotation loops can be formed in both directions of roll. However, the recommendation is to minimize the number of areas n in the interest of achieving a clearly arranged presentation, which is also of practical benefit in terms of space. n=3 has proved a very suitable number of areas in practice.

FIG. 3 shows an embodiment of the rolling effect for three areas. As in the examples shown in FIGS. 1 and 2, the activated area is displayed here in large format in the center while one of the two deactivated areas is displayed in small format above the activated area and the other of the two deactivated areas is displayed in small format below the activated area. To illustrate the rolling effect, the top side of the display can be mentally visualized as being linked to its lower side. In the first illustration of FIG. 3 this means that the top side of area 1 and be thought of as bounding the lower side of area 3. This adjacency relationship will be retained when any deactivated area is activated. The same applies to all other adjacency relationships among the areas. So regardless of which area happens to be activated, the lower side of area 1 will always border the top side of area 2, the lower side of area 2 will always border the top side of area 3, and the lower side of area 3 will always border the top side of area 1. The degrees of freedom with which the areas can be positioned must be restricted exactly as if the areas were located on the surface of a roll. Rolling or rotating of the roll is in each case possible in both directions.

The rolling effect can be particularly advantageously employed for a number n≧3 because it is recognized here by the user as such and makes the user's orientation significantly easier.

FIG. 4 shows the rolling effect for a number of areas n=4. Both directions of roll are used here. As a result, there is still no more than one deactivated area at a time between the respectively activated area and the side of the part of the user interface shared by the areas. Although it would still be possible to use only one direction of roll for a number of areas n=4, as shown in FIG. 3, the display would then be less clearly arranged and, in particular, it would be more difficult to drag user interface image objects accurately from one area to another.

The two directions of roll are arranged vertically one above the other. The three deactivated areas are arranged to the left, to the left above, and directly above the activated area. As a result, they are always in the field of vision of right-handed users, not being obscured by the hand used for operation. The method or data processing system can be changed round accordingly for left-handed operation.

This exemplary embodiment also impressively illustrates how the invention makes it possible at any time to reach any other area from the larger-format, activated area or to drag a user interface image object from the activated area into another area.

FIG. 5 illustrates the flow of motion if the area situated in the corner of the previously activated area is activated. The rolling effect here comprises two mutually perpendicular rolling motions, which, however, are executed not in succession but simultaneously. FIGS. 6 to 8 illustrate the rolling effect for a number of areas n=6. As can be seen, for each motion horizontally and vertically there are groups of areas which are moved with each other. These are the above-mentioned rotation loops. They are shown in the Figures by means of rectangles drawn for combining purposes around the areas represented by circles.

FIG. 8 in turn shows the flow of motion if a previously deactivated area situated in the corner of the previously activated area is activated. The diagonal motions occurring here are combinations of horizontal and vertical motions executed simultaneously.

FIGS. 9 and 10 finally show the rolling effect for a number of areas n=9. The flow of motion for over-corner activation is also shown here as an example.

1. Method for controlling a data processing system via a user interface on which can be displayed in several areas in each case user interface image objects with the calling up of which the execution of defined functions of the data processing system is associated,
wherein the areas share a part of the user interface,
wherein the areas are displayed in different sizes on the user interface, and
wherein an area, if activated, is displayed at a preferred position on the user interface while the other areas are grouped around the activated area.

2. Method according to claim 1
wherein the preferred position is located approximately in the center of the part of the user interface shared by the areas.

3. Method according to one of the preceding claims
wherein an area, if activated, is increased in size.

4. Method according to one of the preceding claims
wherein, if an area is activated, another, previously activated area is deactivated.

5. Method according to claim 4
wherein the area which is deactivated is reduced in size.

6. Method according to one of the preceding claims
wherein the areas are separate.

7. Method according to one of the preceding claims
wherein the user interface is controlled via an instrument for pointing.

8. Method according to one of the preceding claims
wherein a user interface image object is dragged from one area to another by means of the instrument for pointing.

9. Method according to claim 8
wherein the area into which the user interface image object is dragged is activated by dragging of the user interface image object into the area activated.

10. Method according to claim 8 or 9
wherein the user interface image object is displayed at the edge of the area into which it was dragged.

11. Method according to claims 1 and 7
wherein the area which is activated is activated by marking with the aid of the instrument for pointing.

12. Method according to one of the preceding claims
wherein, when the area is activated, the activated area and other areas are positioned so as to produce a rolling effect.

13. Method according to one of the preceding claims
wherein the areas are positioned such that the areas that have not been activated are arranged at the edge or close to the edge of the activated area.

14. Method according to claim 13
wherein the areas are positioned such that two areas are in each case always arranged adjacently along their same edges regardless of which area has been activated.

15. Method according to one of the preceding claims
wherein the active area is displayed as a polygon.

16. Method according to claim 15
wherein the areas are positioned such that a non-activated area or several non-activated areas is/are in each case situated along a side of the polygon which is displayed as the active area.

17. Method according to claim 16
wherein the areas are positioned such that in each case two areas are always arranged adjacently along their same sides regardless of which area has been activated.

18. Method according to one of the preceding claims
wherein the areas are positioned and selected to be of a size such that all areas are displayed on the user interface.

19. Method according to one of the preceding claims
wherein the areas are positioned and selected to be of a size such that no area obscures a partial area of another area.

20. Data processing system with display facilities for displaying a user interface on which can be displayed in several areas in each case user interface image objects with the calling up of which the execution of defined functions of the data processing system is associated
wherein the areas share a part of the user interface,
wherein the areas of the data processing system can be displayed in different sizes on the user interface and which is set up in such a way that an area, if activated, is displayed at a preferred position on the user interface while the other areas are grouped around the activated area.

21. Program product for a data processing system
containing software code sections with which a method according to at least one of claims 1 to 19 can be implemented on a data processing system.
